(19) United States
(12) Patent Application Publication
(10) Pub. No.: US 2008/0043104 A1
(43) Pub. Date: Feb. 21, 2008

(54) Expanded data storage for vehicle-based applications with a periodic duty cycle

(76) Inventors: William Bradford Silveranil, Raleigh, NC (US); Robert Bradley, Morisville, NC (US); Matthew Mikula, Raleigh, NC (US)

Correspondence Address: John L. Sotomayor;Suite 300, 511 Davis Drive, Morisville, NC, 27560, US

(21) Appl. No.: 11/506,806

(22) Filed: Aug. 21, 2006

(51) Int. Cl. H04N 7/18

(52) U.S. Cl. 348/148

(57) ABSTRACT

Mobile Digital Video Recorders (MDVR) for security applications can require extensive storage requirements as video quality, video resolution, and camera counts increase. Frequently, the storage requirements over many days or weeks exceed the capacity of any one storage device leading to the use of multiple storage devices. However, ruggedized storage devices that are usable within a moving vehicle platform are expensive and have lower capacity capabilities per unit, and thus place a limit upon the storage that may be used within any single vehicle. This invention employs a mixed configuration of rugged and non-rugged storage devices in combination with robust control software modules to achieve the total on-board storage requirements of the system economically and without requiring special accommodation within a vehicle for a high number of storage devices.

### TECHNICAL FIELD OF THE INVENTION

The operating environment for mobile digital video recorder and its associated storage when installed within a vehicle is a challenging one. The system must be able to perform without pause for a number of complete duty cycles, each cycle of which commonly lasts for 18 hours, while subjected to vibration, temperature, and shock levels to which stationary equipment is never exposed, and for which standard storage devices are not designed to withstand. Standard storage drives, which are cost effective, cannot maintain continuous operation in this type of environment, and hardened drives built for automotive or military applications, are cost prohibitive in that they may cost as much as 200 times as much as standard storage devices.

Data storage requirements are a limiting factor on the operational capability of a mobile digital video recording (MDVR) system used in security applications. An MDVR system for such applications has extensive storage requirements as system specifications require sufficient storage for multiple duty cycles for each operational vehicle. Storage requirement demands continue to increase over present levels as requirements for video quality, video resolution (higher definition), camera count, and vehicle counts increase. An MDVR system that can meet the storage requirements for multiple duty cycles, can withstand the rugged mobile environment, can be expandable to meet ever growing storage needs, and yet is cost effective is needed.

### BACKGROUND OF THE INVENTION

Typical MDVR systems on the market today attempt to meet storage requirement needs for operational vehicles that have a requirement for 30, 60, and even 90 days of onboard storage. The typical system design for a vehicle-based system with 90 days of onboard storage would require 10 to 12 2.5″ commercial hard drives to be installed within the vehicle. To accomplish this, the hard drives, not normally suitable for use in such a rugged environment, would require elaborate and expensive protection means from on-board environmental conditions to allow them to continue to function. Using 2.5″ commercial drives is an improvement over 3.5″ drives in terms of withstanding the on-board environmental conditions, but at a sacrifice of storage capacity as 2.5″ commercial drives have less than 25% of the capacity of a 3.5″ disk drive. Thus, the storage needs encompass a number of on-duty cycles for each vehicle in the system.

In addition, the elaborate means required for protection of the commercial drives to ensure continued operation in such a rugged environment increases both the installed cost and maintenance cost of the system. A solution is needed that provides protection for standard commercial storage devices within an on-board environment that will provide for temperature, vibration, and shock protection, meet the needs of a vehicle that requires storage for multiple vehicle duty cycles, and provides this protection at a reasonable cost per installed system.

The instant invention is a novel, non-obvious and cost effective means for capturing and storing an integrated stream of video, audio, and meta-data captured by an operating MDVR system by employing a mixed configuration of rugged and non-rugged storage to compensate for the harsh operating environment and yet achieve the total storage requirements of the system across multiple vehicle duty cycles.

### SUMMARY OF THE INVENTION

The instant invention employs a mixed configuration of rugged and non-rugged storage devices, environmental sensors and other vehicle operating sensors, and a set of software modules for management of the storage devices to achieve the total storage requirements of the system without compromising the operational characteristics of the storage devices.

The invention comprises a MDVR and a Mobile Storage Array (MSA) connected by a high speed interface such as External SATA, USB 2.0, or IEEE 1394 and a set of software modules for system command and control. The MSA comprises an array of non-rugged commercial storage components such as 3.5″ hard disk drives with very large capacity, environmental sensors, and power supply, command and control, and environmental sensor data interfaces with the MDVR. The number and type of hard disk drives in the MSA is configured to provide sufficient storage for a configurable time up to 90 days (or more), covering all duty cycles within that configurable time span. The MDVR would also be configured with a rugged storage component such as a FLASH disk drive or automotive-grade hard disk drive of sufficient minimum capacity to record all data captured during a minimum of one or more duty cycles. During normal operation, the non-rugged commercial hard disk drives would be maintained in a non-operating state. In a non-operating state, the non-rugged storage devices consume little or no power, generate little or no heat and can survive environmental conditions that are comparable to the operating specifications of the rugged storage device.

Again, during normal operation the MDVR would capture video, audio, and meta-data creating the necessary integrated data files and storing the information on the rugged storage device internal to the MDVR. The command and control software modules would monitor the system to determine if the vehicle has returned to an idle state or a holding location, and the environmental sensor signals are below pre-set threshold limits for permissible operating conditions. When the enhanced embedded software modules have determined that the vehicle meets these conditions they apply power to the MSA and transfer data files from the rugged storage device in the MDVR to the non-ruggedized disk drives within the MSA.

During the transfer process, the command and control software would add additional meta-data to the files as they are transferred to an enhanced embedded database embodied within the MSA disk drives with location file pointers enabling the searching of files and file meta-data even during periods when the MSA is not operating. If the vehicle leaves an idle state or the environment on the vehicle becomes unsuitable for the operation of the MSA, the command and control software within the MDVR can cease file transfer operations, power down the MSA and continue storing subsequent data on the rugged storage component within the MDVR.

The system also may include additional software command and control components to perform file transfers from rugged storage to the MSA based upon schedule or environment conditions, as the result of a learning algorithm, or perform incremental file transfers during shorter idle times (such as a traffic light or traffic tie-up).

The present invention is an elegant solution to the problems of providing sufficient storage for the collection of critical data in a rugged vehicle environment and in a cost effective manner.

### BRIEF DESCRIPTION OF THE DRAWINGS

FIG. 1: System Block Diagram

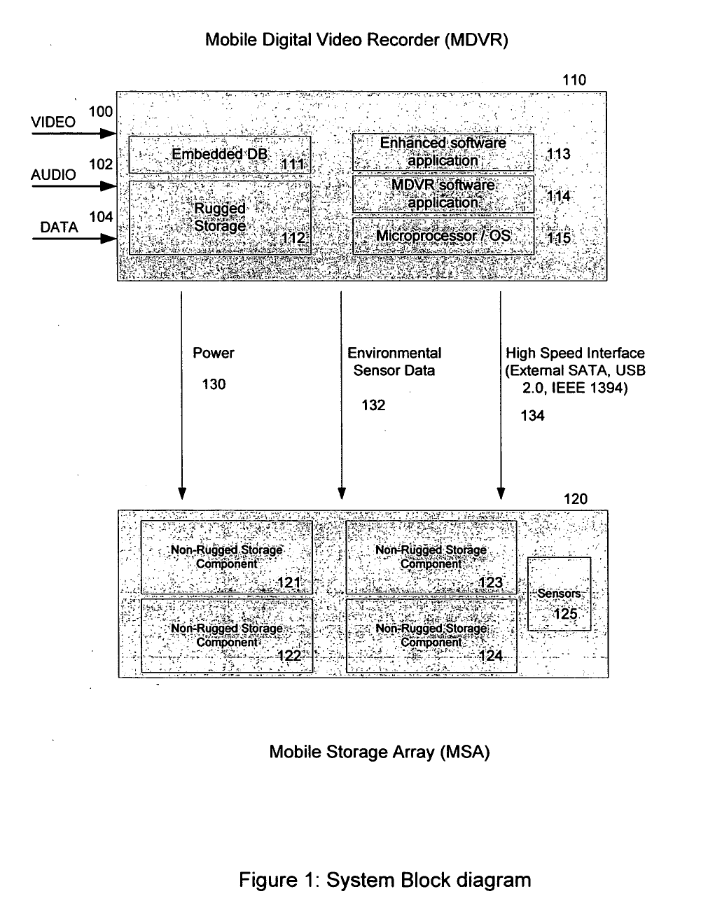

FIG. 2: State Diagram for Process

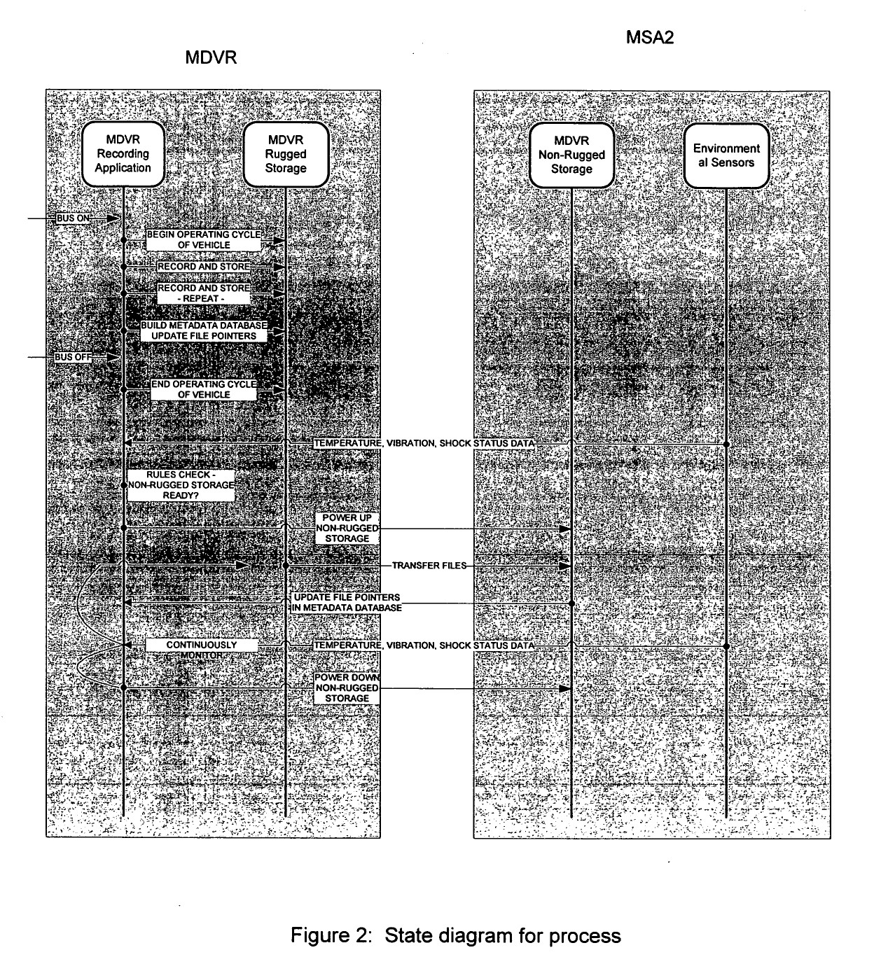

FIG. 3: Process Flow Diagram

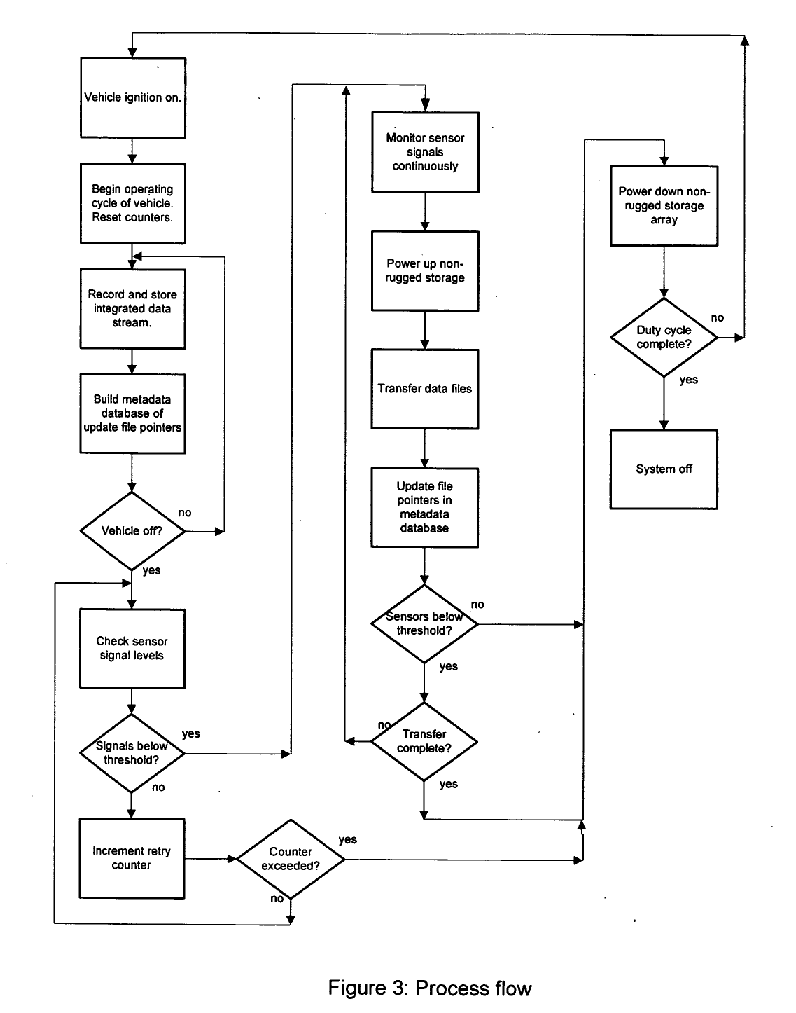

### DETAILED DESCRIPTION OF THE INVENTION

The present invention captures a systemic ability to provide a multi-cycle, where a cycle is defined as one operating day and may be up to 23 hours, data storage capability for video, audio, and metadata (100, 102, 104) that is captured by a vehicle mounted digital video recordation system 110. This invention allows the system to by-pass the temperature, shock, and vibration limits on inexpensive storage devices and device arrays and use them to store data in a rugged environment for later retrieval as required.

The preferred embodiment includes a Mobile Digital Video Recorder (MDVR) 110 system comprising one or more cameras, one or more microphones, data inputs from sensors 132, data connections to embedded vehicle sensors, rugged storage 112 such as automotive-grade hard disk drives or FLASH storage, a control microprocessor 115, and software modules to control the system (113, 114), store and retrieve data, and manage connectivity to components and communications channels outside of the MDVR 110. In the preferred embodiment the MDVR 110 is connected via a high speed communication interface 134, such as External Serial Advanced Technology Attachment (SATA), Universal Serial Bus (USB), or IEEE 1394, a power connection 130, and a sensor data communication pathway 132 to a Mobile Storage Array (MSA) 120 comprising a suite of sensors 125, such as power, temperature, shock, and vibration sensors, software modules for communication and control, power, interface and data connections to the MDVR (130, 132, 134), and sufficient inexpensive storage to provide sufficient storage for a configurable operation time of 90 days or more. For an operational period of 90 days, for example, the MSA would be configured with four 3.5″, 750 Gigabit SATA drives (121-124).

In normal operation mode the MDVR 110 begins an operating cycle upon sensing that the vehicle ignition switch is engaged 300, turning the vehicle on. In an initial state, the MDVR 110 powers up its internal rugged storage component 112 and the MSA 120 is in a non-operating, locked condition. In this state, both the rugged storage device 112 within the MDVR 110 and the inexpensive, non-ruggedized storage devices (121-124) within the MSA 120 meet the requirements for temperature, shock, and vibration required for an in-vehicle mounted system. As the vehicle begins a duty cycle 305 the MDVR 110 enters a record and store state in which video, audio, and metadata are captured during the operation of the vehicle and stored 310 into the operational rugged drive 112 within the MDVR 110. In addition, an MDVR control software 114 module builds a metadata database file 315 within the ruggedized storage device 112 that contains a continually updated list of file pointers to all data files within the rugged storage device.

At the end of an operation duty cycle, the vehicle returns to the depot or parking area where the vehicle is normally stored during the times between duty cycles. The MDVR 110 senses the ignition being turned to the off position 320 and uses this action as the trigger to mark the end of the duty cycle. The MDVR 110 then communicates with the MSA 120 to retrieve temperature, vibration, and shock sensor data from the sensors 132 in the MSA 120. If each of these parameters are below previously established threshold levels 330, as stored within the MDVA processor memory 115, the MDVR control software 114 determines that there will be no damage to the non-ruggedized storage within the MSA 120 if the drives are operational. The MDVA 110 then supplies power to the non-ruggedized storage array 350.

In the preferred embodiment, with the non-ruggedized storage array powered up 350 the system begins transferring captured data files 355 from the MDVR rugged storage drive 112 as well as the metadata database 360 containing the file pointers for all of the data files captured. The high speed data interface 134 (SATA, USB, or 1394) is capable of transferring data from the rugged storage device to the non-rugged storage drives at a rate from 1 gigabyte up to 4 gigabytes per minute. During the process of transferring the data files, the signals from the temperature, shock, and vibration sensors within the MSA 120 are continually monitored 345 by the monitoring software module within the MDVR 113. If the output from the sensors exceeds the preset threshold values 365 stored within the MDVR processor memory 114, the file transfer is brought to an orderly stop. A pointer is maintained within the processor memory identifying the position within the rugged storage medium at which the data transfer was stopped. The MDVR control software module 113 then powers down the MSA 120, allowing the non-ruggedized storage devices (121-124) to return to a state within which the non-ruggedized storage devices (121-124) are resistant to temperature, vibration, and shock levels as before.

If, instead, the signals from the temperature, shock, and vibration sensors 132 within the MSA 120 remain below the preset threshold limit values stored within the MDVR processor memory 115, the MSA storage devices (121-124) remain powered-up and the MDVR control software 113 continues to download captured data files 355 and the database of file pointers 360 until all data has been transferred to the MSA 120. The MDVR control software module 113 then powers down the MSA 120, returning the non-ruggedized storage devices (121-124) to their initial state.

The vehicle mounted system is now ready for another duty cycle for the vehicle. This process repeats until the system managers at a permanent data storage facility are prepared to transfer the data files and metadata database of file pointers from the vehicle on-board MSA 120 to a permanent data storage facility where the data will be stored for future evidentiary and analysis needs.

The preferred embodiment is only one of a number of scenarios under which the instant invention may be configured to securely store data files and data file pointer in the inexpensive non-ruggedized MSA storage devices (121-124). In another embodiment, the data and data file pointers may be retrieved from the ruggedized storage 112 within the MDVR 110 based upon a scheduled time. In this embodiment, regardless of whether the vehicle has returned to a parking facility or not, the MDVR control software 113 would, on a pre-set scheduled time, check the MSA sensors 125 for temperature, shock, and vibration sensor signal levels 132. If the signal levels do not exceed the pre-set threshold levels, the MDVR control software module 113 would power-up the storage devices (121-124) within the MSA 120 and perform file 355 and file pointer 360 data transfer actions. The MDVR control software 113 continuously monitors the temperature, shock, and vibration sensor signal levels. If the sensor signal levels remain below the threshold levels, the MDVR 110 continues file 355 and file pointer 360 data transfer until all files have been transferred to the MSA 120. The MDVR control software 113 then powers down the MSA storage devices (121-124) until the next scheduled data transfer time point. If the sensor signal levels exceed the acceptable threshold signal levels, the MDVR control software 113 discontinues the file and file pointer data transfer and powers down the MSA storage devices (121-124) until the next scheduled data transfer time point.

In another embodiment, the MDVR control software module 113 continuously monitors the temperature, shock, and vibration sensor signals 345 anytime the vehicle is in a stopped or idle state. If the signal levels do not exceed the pre-set threshold levels, the MDVR control software module 113 would power-up the storage devices (121-124) within the MSA 120 and perform file 355 and file pointer 360 data transfer actions until all file and file pointer data is transferred to the MSA 120 or until the vehicle is no longer in a stopped or idle state. In this fashion the data files and file pointers are incrementally added to the MSA storage devices (121-124) during each duty cycle of the vehicle.

The MDVR control software module 113 may also contain a learning module such that the control software is able to perform predictive analysis of the vehicle duty cycle. This predictive analysis software module learns when, within the vehicle duty cycle, there are stopped, idle, and parked times during which the MDVR control software 113 may assume, with a high degree of confidence, that the temperature, shock, and vibration sensor signals are below the threshold levels for theses sensors and may then power up the MSA storage drives (121-124), perform file and file pointer data activity, and power down the MSA storage drives (121-124) during the predicted window of time that the vehicle is stopped, idle or parked, and the sensor signals are below the signal threshold levels.

The embodiments enumerated within this document are not intended to be comprehensive of all possible embodiments of the instant invention. The invention is not limited to the embodiments recited herein which are used to illustrate the preferred embodiments for operation of the invention.

While this invention has been particularly shown and described with reference to preferred embodiments thereof, it will be understood by those skilled in the art that various changes in form and details may be made therein without departing from the spirit and scope of the invention as defined by the appended claims.

We claim:

1. A system installed within a vehicle for capturing a digitally integrated stream of data comprising at least two of video, audio, and metadata and storing said integrated stream of data for multiple vehicle operating cycles within on-board storage comprising:
a Mobile Digital Video Recorder (MDVR);
a Mobile Storage Array (MSA);
means for providing a high-speed data connection between said MDVR and said MSA;
means for transferring environmental sensor data from said MSA to said MDVR; a wired power connection from said MDVR to said MSA to supply power to said MSA;
software modules maintained within a non-volatile memory device within said MDVR;
environmental sensor devices installed adjacent to said MSA;
wherein said MDVR and said MSA operate under the control of said software modules to capture and store said digitally integrated stream of data whenever operational conditions do not exceed pre-set limits as determined by signal levels from said sensor devices.

2. A system according to claim 1 installed within a vehicle for capturing a digitally integrated stream of data comprising at least two of video, audio, and metadata and storing said integrated stream of data for multiple vehicle operating cycles within on-board storage further comprising:
wherein said MDVR comprises one or more cameras, one or more audio capture devices, a rugged storage device such as a FLASH drive or automotive-grade hard disk drive, a power supply, a microprocessor and integral non-volatile memory, command and control software program modules, and power, sensor data, and command and control interfaces with said MSA.

3. A system according to claim 1 installed within a vehicle for capturing a digitally integrated stream of data comprising at least two of video, audio, and metadata and storing said integrated stream of data for multiple vehicle operating cycles within on-board storage further comprising: wherein said MSA comprises an array of non-rugged commercial storage components such as 3.5″ hard disk drives each of which having a capacity in excess of 500 Gigabytes, environmental sensors, and power, sensor data, and command and control interfaces with said MDVR.

4. A system according to claim 3 installed within a vehicle for capturing a digitally integrated stream of data comprising at least two of video, audio, and metadata and storing said integrated stream of data for multiple vehicle operating cycles within on-board storage further comprising:
said environmental sensors comprises a plurality of sensors for measuring environmental variables such as temperature, shock, vibration, and power levels within the MSA housing;
and wherein said measured environmental variable signal values are transmitted to said MDVR across a communication connection dedicated to the transmission of environmental sensor data.

5. A system according to claim 1 installed within a vehicle for capturing a digitally integrated stream of data comprising at least two of video, audio, and metadata and storing said integrated stream of data for multiple vehicle operating cycles within on-board storage further comprising: said command and control interface comprises a high speed data communication interface such as External SATA, USB 2.0, or IEEE 1394.

6. A system according to claim 1 installed within a vehicle for capturing a digitally integrated stream of data comprising at least two of video, audio, and metadata and storing said integrated stream of data for multiple vehicle operating cycles within on-board storage further comprising:
said command and control software modules continuously monitor said environmental sensor signals and compare said sensor signals against pre-set threshold limits stored within MDVR non-volatile memory.

7. A system according to claim 6 installed within a vehicle for capturing a digitally integrated stream of data comprising at least two of video, audio, and metadata and storing said integrated stream of data for multiple vehicle operating cycles within on-board storage further comprising:
wherein said command and control software modules manage the transfer of data files from said rugged storage within said MDVR to non-rugged storage devices within said MSA only when all sensor signal levels remain below pre-set threshold limits.

8. A system according to claim 2 installed within a vehicle for capturing a digitally integrated stream of data comprising at least two of video, audio, and metadata and storing said integrated stream of data for multiple vehicle operating cycles within on-board storage further comprising:
a wired power connection between said MDVR and said MSA;
wherein said power connection is sufficient to supply adequate operational power from said MDVR to said MSA.

9. A process used with a Mobile Digital Video Recorder system interconnected with a Mobile Storage Array and installed within a vehicle for capturing a digitally integrated stream of data comprising at least two of video, audio, and metadata and storing said integrated stream of data for multiple vehicle operating cycles within on-board storage comprising the steps of:
initiating connectivity between an MDVR and an MSA installed within a vehicle; a control software module within said MDVR receives an ignition on trigger signal, powering up said MDVR;
capture and store an integrated stream of data within said MDVR;
means for transferring environmental sensor data from said MSA to said MDVR; comparing said environmental sensor data against preset threshold levels;
when vehicle is stopped and said environmental sensor signal levels are below said threshold levels apply power to said MSA;
transferring files under management of a software control module within said MDVR from said MDVR to said MSA;
if all files transferred, removing power from said MSA;
powering down said MDVR until the next ignition on trigger signal.

10. A process according to claim 9 used with a Mobile Digital Video Recorder system interconnected with a Mobile Storage Array and installed within a vehicle for capturing a digitally integrated stream of data comprising at least two of video, audio, and metadata and storing said integrated stream of data for multiple vehicle operating cycles within on-board storage further comprising the steps of:
wherein the step of initiating connectivity between said MDVR and said MSA includes power, environmental sensor data, and high speed data interface communication connections.

11. A process according to claim 10 used with a Mobile Digital Video Recorder system interconnected with a Mobile Storage Array and installed within a vehicle for capturing a digitally integrated stream of data comprising at least two of video, audio, and metadata and storing said integrated stream of data for multiple vehicle operating cycles within on-board storage further comprising the steps of:
initiating a high speed data interface comprising External SATA, USB 2.0, or IEEE 1394 standard connections.

12. A process according to claim 9 used with a Mobile Digital Video Recorder system interconnected with a Mobile Storage Array and installed within a vehicle for capturing a digitally integrated stream of data comprising at least two of video, audio, and metadata and storing said integrated stream of data for multiple vehicle operating cycles within on-board storage further comprising the steps of:
wherein capturing and storing an integrated stream of data within said MDVR further comprises the steps of:
capturing an integrated stream of data comprising video, audio, and metadata and storing said integrated stream of data within a rugged storage device within said MDVR;
building, under software module control, a metadata database of update file pointers for all files within said integrated stream of data.

13. A process according to claim 9 used with a Mobile Digital Video Recorder system interconnected with a Mobile Storage Array and installed within a vehicle for capturing a digitally integrated stream of data comprising at least two of video, audio, and metadata and storing said integrated stream of data for multiple vehicle operating cycles within on-board storage further comprising the steps of:
wherein said environmental sensor data preset threshold levels are stored within non-volatile memory within said MDVR prior to operation of the system.

14. A process according to claim 9 used with a Mobile Digital Video Recorder system interconnected with a Mobile Storage Array and installed within a vehicle for capturing a digitally integrated stream of data comprising at least two of video, audio, and metadata and storing said integrated stream of data for multiple vehicle operating cycles within on-board storage further comprising the steps of:
initiating a software module within said MDVR to receive said environmental sensor data signals;
monitoring said environmental sensor data signals continuously during operation of the system.

15. A process according to claim 9 used with a Mobile Digital Video Recorder system interconnected with a Mobile Storage Array and installed within a vehicle for capturing a digitally integrated stream of data comprising at least two of video, audio, and metadata and storing said integrated stream of data for multiple vehicle operating cycles within on-board storage further comprising the steps of:
wherein said MSA comprises a plurality of non-rugged storage devices; said non-rugged storage devices receive power from said MDVR only when the vehicle is not moving and said environmental sensor data signals are below pre-set threshold levels;
after power is applied to said MSA, a computer software module within said MDVR is operational to transfer files from said MDVR rugged storage device to said MSA non-rugged storage devices.

16. A process according to claim 15 used with a Mobile Digital Video Recorder system interconnected with a Mobile Storage Array and installed within a vehicle for capturing a digitally integrated stream of data comprising at least two of video, audio, and metadata and storing said integrated stream of data for multiple vehicle operating cycles within on-board storage further comprising the steps of:
said file transfer comprises said integrated stream data files and updated file pointers within said metadata database.

17. A process according to claim 9 used with a Mobile Digital Video Recorder system interconnected with a Mobile Storage Array and installed within a vehicle for capturing a digitally integrated stream of data comprising at least two of video, audio, and metadata and storing said integrated stream of data for multiple vehicle operating cycles within on-board storage further comprising the steps of:
said removal of power to said MSA occurs when file transfers are completed; or said removal of power to said MSA occurs when said vehicle begins movement once again;
or said removal of power to said MSA occurs when said environmental sensor signal levels exceed preset threshold levels stored within said MDVR.

18. A computer program product embedded within a computer readable medium within a Mobile Digital Video Recorder system interconnected with an Mobile Storage Array and installed within a vehicle for capturing a digitally integrated stream of data comprising at least two of video, audio, and metadata and storing said integrated stream of data for multiple vehicle operating cycles within on-board storage comprising:
software instructions for enabling the MDVR to control operations for data gathering and interconnectivity with the MSA;
software instructions for determining when gathered data is stored in rugged memory or non-rugged memory;
software modules for monitoring vehicle and environmental sensor data; and software instructions for system on and off cycles.

19. A computer program product according to claim 18 embedded within a computer readable medium within a Mobile Digital Video Recorder system interconnected with an Mobile Storage Array and installed within a vehicle for capturing a digitally integrated stream of data comprising at least two of video, audio, and metadata and storing said integrated stream of data for multiple vehicle operating cycles within on-board storage further comprising:
Under software control, capturing an integrated stream of data comprising video, audio, and metadata and storing said integrated stream of data within a rugged storage device within said MDVR;
building, under software module control, a metadata database of update file pointers for all files within said integrated stream of data.

20. A computer program product according to claim 18 embedded within a computer readable medium within a Mobile Digital Video Recorder system interconnected with an Mobile Storage Array and installed within a vehicle for capturing a digitally integrated stream of data comprising at least two of video, audio, and metadata and storing said integrated stream of data for multiple vehicle operating cycles within on-board storage further comprising:
under software control providing power from said MDVR only when the vehicle is not moving and said environmental sensor data signals are below pre-set threshold levels;
after power is applied to said MSA, a computer software module within said MDVR is operational to transfer files from said MDVR rugged storage device to said MSA non-rugged storage devices.

21. A computer program product according to claim 18 embedded within a computer readable medium within a Mobile Digital Video Recorder system interconnected with an Mobile Storage Array and installed within a vehicle for capturing a digitally integrated stream of data comprising at least two of video, audio, and metadata and storing said integrated stream of data for multiple vehicle operating cycles within on-board storage further comprising:
under computer software control removal of power to said MSA occurs when file transfers are completed;
or said removal of power to said MSA occurs when said vehicle begins movement once again;
or said removal of power to said MSA occurs when said environmental sensor signal levels exceed preset threshold levels stored within said MDVR.

22. A computer program product according to claim 18 embedded within a computer readable medium within a Mobile Digital Video Recorder system interconnected with an Mobile Storage Array and installed within a vehicle for capturing a digitally integrated stream of data comprising at least two of video, audio, and metadata and storing said integrated stream of data for multiple vehicle operating cycles within on-board storage further comprising:
a computer software module for determining system operational cycle and duty cycle;
wherein the computer software module defines multiple operational cycles for the system within each duty cycle and places the system in rest mode between operational cycles.
